(19) United States
(12) Patent Application Publication
(10) Pub. No.: US 2012/0266007 A1
(43) Pub. Date: Oct. 18, 2012

(54) INFORMATION TECHNOLOGY (IT) POWER SUPPLY, POWER DISTRIBUTION, OR ENVIRONMENTAL CONTROL APPARATUS AND METHOD

(75) Inventors: Ramesh J. Menon, Cary, NC (US); Thomas J. Overberg, Apex, NC (US); Pradeep K. Nandam, Cary, NC (US); Matthew S. Effron, Raleigh, NC (US); Ronald L. Clark, Knightdale, NC (US); Darren T. Barr, Bradenton, FL (US)

(73) Assignee: Eaton Corporation, Cleveland, OH (US)

(21) Appl. No.: 13/450,125

(22) Filed: Apr. 18, 2012

Related U.S. Application Data
(60) Provisional application No. 61/476,552, filed on Apr. 18, 2011.

(51) Int. Cl. G06F 1/26

(52) U.S. Cl. 713/340; 713/300

(57) ABSTRACT

An information technology (IT) equipment power supply, power distribution, or environmental control apparatus includes at least one input configured to operably connect to a power source, at least one output configured to deliver power, at least one processor in circuit with the input or the output and configured to receive data representing operational parameters of the input and the output. The apparatus further includes at least one wireless transmitter in circuit with the processor and configured to wirelessly transmit data representing the operational parameters.

### PRIORITY

This application claims priority to U.S. Patent Application No. 61/476,552, filed Apr. 18, 2011. The entirety of that application is incorporated herein.

### FIELD OF THE INVENTION

The present disclosure relates to the field of information technology (IT) equipment. In particular, the present disclosure relates to power supply, power distribution, and environmental control systems and methods used in IT applications.

### BACKGROUND

As IT systems grow in complexity with increasing numbers of servers, maintaining the conditions for proper operation of the IT systems becomes more difficult. Collecting and analyzing information regarding equipment such as power supply, power distribution, and environmental control units that are responsible for maintaining proper operating conditions of the IT systems becomes exceedingly important.

One example where this information is particularly useful is in data center applications. As the costs of energy and, in particular, electricity increases, having up-to-date information regarding power delivery to the various IT systems within the data center becomes increasingly important.

This information enables data center managers to optimize power consumption via adequate planning, right-sizing of energy supply to data center equipment, power balancing, load shedding, overload protection, efficient problem diagnosis, and so on. Additionally, in some data center applications, managers may be required to maintain up-to-date power consumption information in order to monitor reliability and reduce troubleshooting time in case of failure.

### SUMMARY OF THE INVENTION

A power supply comprises at least one input port configured to operably connect to a power source. The power supply further comprises at least one output port configured to operably connect to a power load. The power supply further comprises at least one processor operably connected to the at least one input port and the at least one output port and configured to receive data representative of operational parameters of the at least one input port and the at least one output port. The power supply further comprises at least one transmitter operably connected to the at least one processor and configured to transmit data representative of the operational parameters.

An information technology (IT) equipment power supply, power distribution, or environmental control apparatus comprises at least one input configured to operably connect to a power source. The apparatus further comprises at least one output configured to deliver power. The apparatus further comprises at least one processor in circuit with the at least one input and the at least one output and configured to receive data representing operational parameters of the at least one input and the at least one output. The apparatus further comprises at least one wireless transmitter in circuit with the at least one processor and configured to wirelessly transmit data representing the operational parameters.

A method for wirelessly communicating operational parameters of an information technology (IT) equipment power supply, power distribution, or environmental control apparatus, the method comprises the step of an apparatus receiving power to at least one input from a power source. The method further comprises the step of the apparatus outputting power from at least one output. The method further comprises the step of a processor detecting operational parameters associated with at least one of the at least one input and the at least one output. The method further comprises the step of a transceiver communicating wireless signals including data representing the operational parameters of the at least one of the at least one input and the at least one output.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an exemplary embodiment of a power distribution system disposed in a server rack.

FIG. 2 illustrates another exemplary embodiment of a power distribution system disposed in a server rack.

FIG. 3 illustrates a block diagram of an exemplary power distribution system including a remote device.

FIG. 4 is a flow chart illustrating an example method for wirelessly communicating operational parameters of an information technology (IT) equipment power supply, power distribution, or environment control apparatus.

FIG. 5 is a flow chart illustrating another example method for wirelessly communicating operational parameters of an information technology (IT) equipment power supply, power distribution, or environment control apparatus.

### DETAILED DESCRIPTION

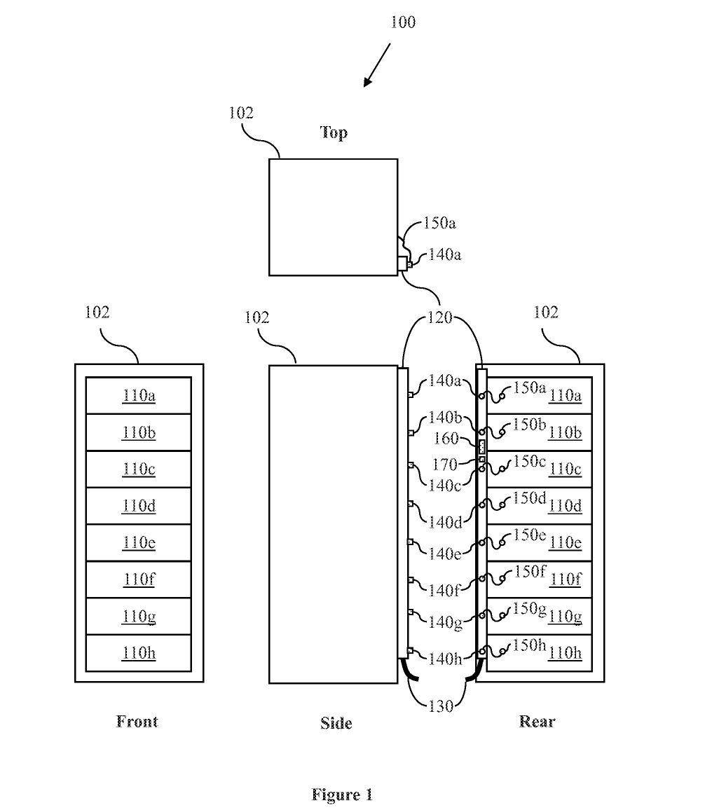

FIG. 1 illustrates an exemplary embodiment of a power distribution system 100. Power distribution system includes a power distribution unit (PDU) 120 disposed in a server rack 102. The server rack 102 includes eight servers 110a-h. Other server rack configurations may include less or more than eight servers. The PDU 120 is mounted vertically along the rear of the rack 102. In other embodiments, the PDU 120 mounts in configurations other than vertical. The PDU 120 includes an input connection 130. The PDU 120 receives power via the input connection 130. The PDU 120 also includes power outputs 140a-h that distribute power to the servers 110a-h. In the illustrated embodiment, the PDU 120 includes eight power outputs 140a-h to match the number of servers 110a-h or server slots in the rack 102. In other embodiments, the PDU 120 includes less or more than eight power outputs. Each of the servers 110a-h receives power from the power outputs 140a-h via connections 150a-h.

The PDU 120 includes a display 160 for a user or data center manager to monitor the status of the PDU 120. For example, the display 160 may enable a user to monitor operational parameters such as the current that each of the power outputs 140a-h delivers to the servers 110a-h. In the illustrated embodiment, the PDU 120 further includes a control interface 170 for a user or data center manager to control the operation of the PDU 120. For example, via the control interface 170, a user may shut-off power out of the PDU 120 or a user may shut-off power out of a specific one of the power outputs 140a-h. Control interface 170 may be, for example, a button, a switch, or other similar control. The display 160 and the control interface 170 together constitute a user interface which may include other features helpful to monitor or control the operation of the PDU 120. In an example embodiment (not shown), display 160 and control interface 170 may be combined into a single integrated control interface. For example, a user may monitor the PDU 120 via a touch screen display and also control operation of the PDU 120 via the touch screen display.

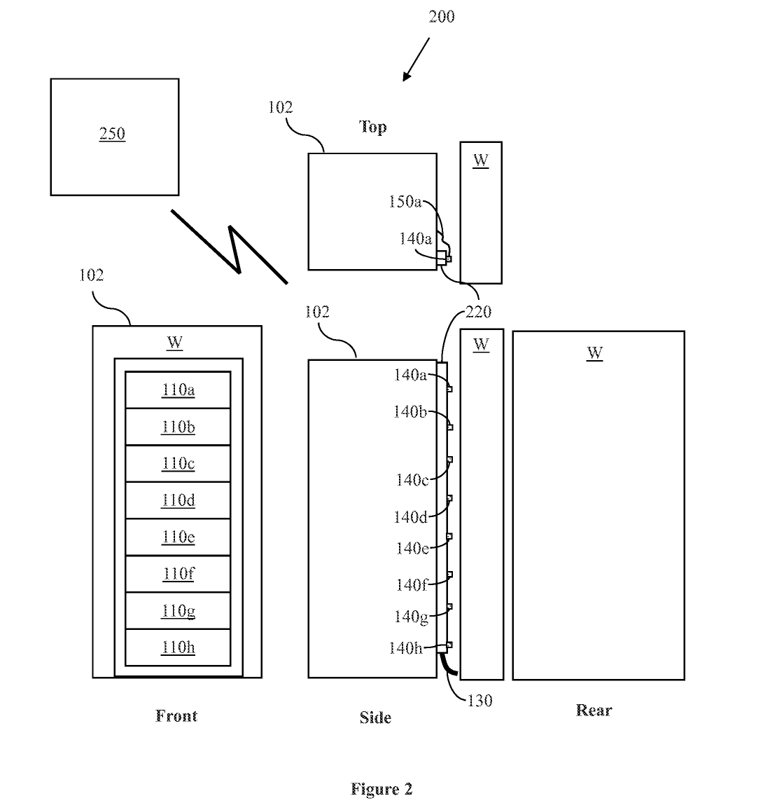

FIG. 2 illustrates another exemplary embodiment of a power distribution system 200. Power distribution system 200 includes a power distribution unit 220 disposed in a server rack 102. In order to maximize space in the data center, racks, such as server rack 102, are commonly installed with their rear in close proximity to a wall, such as wall W, or another rack, or other structure. The close proximity of the rear of rack 102 to the wall W may make it difficult for a user to gain access to the display 160 or the control 170. Thus, in an example embodiment, power distribution system 100 further includes a remote device 250 for communicating with PDU 220 and for monitoring operational parameters of PDU 220.

It should be understood that, although FIG. 2 illustrates remote device 250 communicating wirelessly with PDU 220, remote device 250 may also be configured to communicate with PDU 220 via a wired connection.

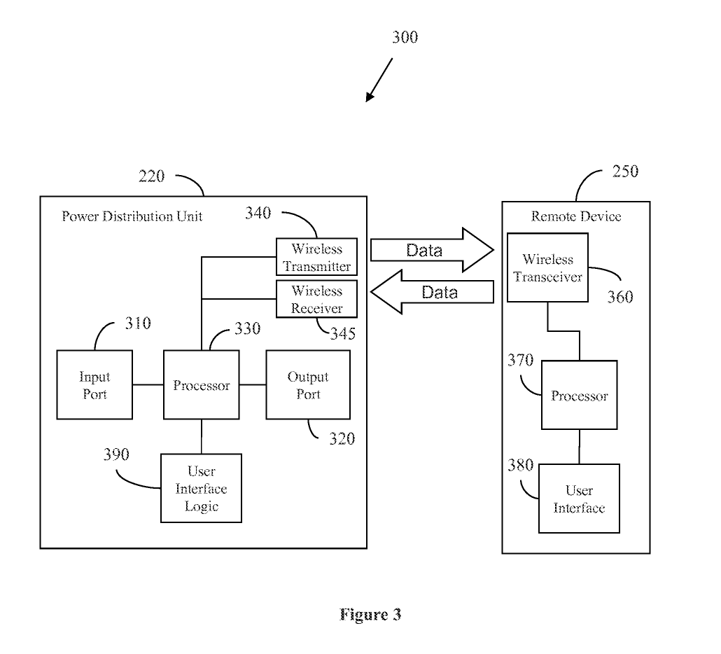

FIG. 3 illustrates a block diagram 300 of the exemplary power distribution system 200 of FIG. 2. Power distribution system 200 includes a PDU 220 and a remote device 250. The PDU 220 distributes power to information technology (IT) equipment within, for example, a data center. Although, for ease of explanation, this disclosure discusses embodiments of the present invention in the context of a PDU, the present invention is also applicable to other power delivering or power distribution equipment within the IT or data center environment such as power supply units, environmental control units, and so on.

The PDU 220 includes an input port 310 that connects to a power source. For example, the input port 310 may connect to an electrical service feed, to an upstream power distribution unit, to an uninterruptible power supply, to battery backup, and so on. The input port 310 may include electro/mechanical connections such as socket/plug combinations, terminal blocks, lugs, bolts, and so on. The electro/mechanical connections may be fixed or removable connections. In one embodiment (not shown), the PDU 220 includes multiple input ports.

In some embodiments (not shown), the power distribution system 200 may include a power supply unit or an environmental control unit instead of a PDU. In such embodiments, the input port may also connect to an electrical service feed, to a power distribution unit, to an uninterruptible power supply, to battery backup, and so on.

The PDU 220 further includes an output port 320 to which IT equipment connects for the PDU 300 to distribute power to the IT equipment. Examples of IT equipment that may connect to the PDU 300 include mainly computer servers, but also monitor displays, peripheral equipment, and so on. In embodiments (not shown) where the power distribution system 200 includes a power supply instead of a PDU, examples of IT equipment that may connect to an output port of the power supply include PDU, computer servers, monitor displays, peripheral equipment, backup equipment including batteries, and so on. In embodiments (not shown) where the power distribution system 200 includes an environmental control unit, the output port may distribute thermal power (measured in, for example, BTU/h) within the data center in the form of heat or heat removed.

The PDU 220 includes a processor 330. In one embodiment, the processor 330 operably connects to the input port 310. In another embodiment, the processor operably connects to the output port 320. In yet another embodiment, the processor 330 operably connects to both the input port 310 and the output port 320.

In one embodiment, the processor 330 receives data representing operational parameters of the input port 310 or the output port 320. The operational parameters may include current, voltage, power (in Watts, VA, BTU/h, and so on), real power, reactive power, energy (BTU, joules, and so on), power factor, harmonic distortion, and so on. The processor 330 may receive data representing measured or calculated operational parameters of the input port 310 or the output port 320. The processor 330 may also receive data representing measured operational parameters and convert the data representing the measured operational parameters into calculated parameters. For example, the processor 330 may receive measured current and voltage, and from these parameters calculate instantaneous power.

In another embodiment, the processor 330 transmits signals controlling functionality of the input port 310 or the output port 320. For example, in one embodiment, the processor 330 transmits a turn-off signal to a relay or other interrupting device associated with the output port 320. The turn-off signal commands the relay or other interrupting device to interrupt or turn-off power to the output port 320.

The PDU 220 further includes a wireless transmitter 340 operably connected to the processor 330. The transmitter 340 transmits wireless signals including data representing the operational parameters. For example, the transmitter 340 may transmit wireless signals including data representing the measured current or voltage, or the calculated power at the input port 310 or the output port 320.

In one embodiment, the PDU 220 further includes a receiver 345 that receives wireless signals including data representing operational parameters. In one embodiment, the operational parameters include set points or thresholds related to the functionality of the input port 310 or the output port 320. For example, the receiver 345 may receive wireless signals including data representing an input port voltage threshold. If the voltage measured at the input port 310 exceeds the voltage threshold, the processor 330 turns off the input port 310 or the output port 320. In another example, the receiver 345 may receive wireless signals including data representing a remote output port turn-off signal. In response to the output port turn-off signal, the processor 330 turns off the output port 320. In an example embodiment, transmitter 340 and receiver 345 may be a single device such as a transceiver (not shown).

Although the transmitter 340 is illustrated as separate from the receiver 345, it should be understood that the transmitter 340 and the receiver 345 may be part of the same component (i.e., a transceiver). Although the transmitter 340 and the receiver 345 are illustrated as separate from the processor 330 it should be understood that the transmitter 340, the receiver 345, or the processor 330 may be part of the same component.

The wireless transmitter 340 and the wireless receiver 345 are configured to wirelessly communicate with a remote device 250. The remote device 250 includes a wireless transceiver 360, a processor 370, and a user interface 380. Via the user interface 380, a user or data center manager can monitor operational parameters of the input port 310 or the output port 320 transmitted by the PDU 220 through the wireless transmitter 340 and received by the remote device 250 through the wireless transceiver 360. For example, a user may monitor the measured voltage or current, or the calculated power at the output port 320. In one embodiment, the PDU 220 transmits only measured operational parameters to the remote device 250 and the processor 370 of the remote device 250 calculates operational parameters based on the received measured operational parameters. The remote device 250 may then display the calculated operational parameters via the user interface 380.

In one embodiment, via the user interface 380, a user or data center manager can control operational parameters of the input port 310 or the output port 320. For example, via the user interface 380 the user or data center manager may set an input port voltage threshold. The remote device 250 transmits the input port voltage threshold to the PDU 220. If the voltage measured at the input port 310 exceeds the voltage threshold, the processor 330 tuns off the input port 310 or the output port 320. In another example, via the user interface 380 the user or data center manager may command the output port 320 off. In that example, the remote device 250 transmits an output port turn-off signal to the PDU 220, and the processor 330 turns off the output port 320 in response to the output port turn-off signal.

The PDU 220 and the remote device 250 communicate directly with each other via wireless signals without the necessity of additional infrastructure such as a computer network. In one embodiment, the direct communication between the PDU 220 and the remote device 250 could be implemented in a non standard communications protocol. In another embodiment, the direct communication between the PDU 220 and the remote device 250 is implemented in a standard communication protocol (e.g., Wi-Fi (IEEE 802.11), Bluetooth (IEEE 802.15.1), Zigbee (IEEE 802.15.4), combinations thereof, and so on). While individual network protocols or standards are described, it is to be appreciated that communications between the PDU 220 and the remote device 250 may be implemented as combinations thereof.

in one embodiment, the remote device 250 is a dedicated device designed specifically to communicate with IT power distribution or generation equipment such as PDU 220. In another embodiment, the remote device 250 is a non-dedicated device. For example, the remote device 250 may be one or a combination of various devices known in the art (e.g., personal digital assistant, smart phone, wireless telephone, cellular telephone, tablet computer, and so on).

In one embodiment, the user interface 380 incorporates a dedicated application (e.g., an app) designed specifically to communicate with IT power distribution or generation equipment such as PDU 220. In another embodiment, the user interface 380 incorporates a non-dedicated interface such as a web browser. The PDU 220 may generate web pages viewable through the web browser in the remote device 250. For example, the PDU 220 may generate an operational parameters web page incorporating the various operational parameters of the input port 310 or the output port 320 and transmit the operational parameters web page to the remote device 250 for display via the user interface 380. In one embodiment, the PDU 220 transmits the operational parameters and the remote device 250 generates the output (e.g., web page) to be displayed via the user interface 380.

In one embodiment, the user interface 380 incorporates an input mechanism (e.g., keyboard, buttons, click wheel, track ball, touch screen, voice command, and so on) that a user or data center manager can operate to interface with the remote device 250.

The remote device 250 may request and the PDU 220 may communicate the operational parameter information through the direct connection between the wireless transmitter 340, the wireless receiver 345, and the wireless transceiver 360 for display via the user interface 380. Alternatively, the PDU 220 may communicate the operational parameters information to the remote device 250 without receiving a request.

In one embodiment, the PDU 220 may require the remote device 250 to provide credentials such as username, password, account number, security key, MAC number and so on, or a combination thereof in order to communicate with the PDU 220. The PDU 220 may grant or deny access based on the credentials that the remote device 250 provides. In another embodiment, the credentials required from the remote device 250 are those specified in existing protocols associated with the direct wireless communication between the PDU 220 and the remote device 250 (e.g., Wi-Fi Protected Access (WPA) for Wi-Fi connections, and so on).

In one embodiment, the PDU 220 further includes a user interface logic 390. The remote device 250 transmits and the PDU 220 receives a signal including data identifying the remote device 250 or the user interface 380. The user interface logic 390 determines a format in which the data representing the operational parameters is transmitted based on the data identifying the remote device 250 or the user interface 380. For example, if the remote device 250 transmits and the PDU 220 receives a signal including data identifying the remote device 250 as a particular dedicated device, the user interface logic 390 determines a format in which the data representing the operational parameters will be transmitted that is tailored to the particular dedicated device. In another example, if the remote device 250 transmits and the PDU 220 receives a signal including data identifying the remote device 250 as a particular non-dedicated device (e.g., a particular smart phone model) the user interface logic 390 determines a format in which the data representing the operational parameters will be transmitted that is tailored to the particular non-dedicated device.

In an example embodiment, PDU 220 also includes a display and a control interface (not shown) for monitoring PDU 220 and for controlling PDU 220. Thus, a user has the option of either communicating with and monitoring PDU 220 at a server rack or remotely via remote device 250.

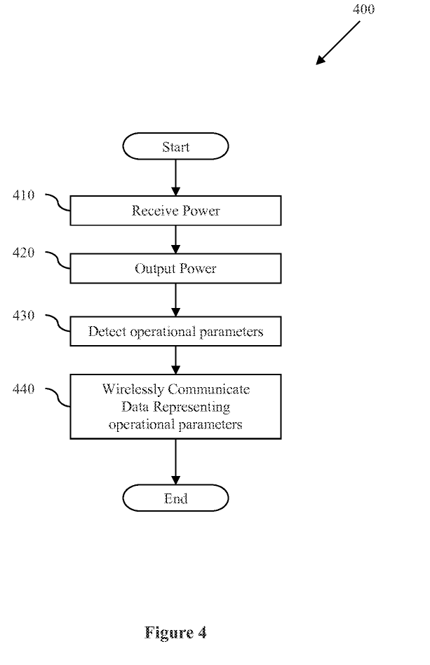

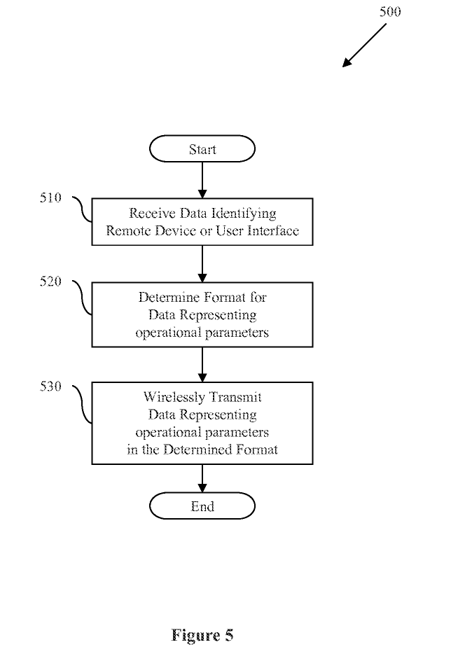

Example methods may be better appreciated with reference to the flow diagrams of FIGS. 4 and 5. While for purposes of simplicity of explanation, the illustrated methodologies are shown and described as a series of blocks, it is to be appreciated that the methodologies are not limited by the order of the blocks, as some blocks can occur in different orders or concurrently with other blocks from that shown or described. Moreover, less than all the illustrated blocks may be required to implement an example methodology. Furthermore, additional or alternative methodologies can employ additional, not illustrated blocks.

In the flow diagrams, blocks denote “processing blocks” that may be implemented with logic. The processing blocks may represent a method step or an apparatus element for performing the method step. A flow diagram does not depict syntax for any particular programming language, methodology, or style (e.g., procedural, object-oriented). Rather, a flow diagram illustrates functional information one skilled in the art may employ to develop logic to perform the illustrated processing, it will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques.

FIG. 4 is a flow chart illustrating an example method 400 for wirelessly communicating operational parameters of an information technology (IT) equipment power supply, power distribution, or environmental control apparatus. At 410, an apparatus receives power at an input from a power source. At 420, the apparatus outputs power at an output. In one embodiment, the outputted power is electrical power measured in Watts, VA, and so on. In another embodiment, the outputted power is thermal power measured in BTU/h, joules/sec, and so on.

At 430, a processor detects operational parameters associated with the input and the output. The operational parameters may include current, voltage, power (in Watts, VA, BTU/h, and so on), real power, reactive power, energy (BTU, joules, and so on), power factor, harmonic distortion, and so on. In one embodiment, detecting the operational parameters includes detecting set points or thresholds associated with the input or the output as received from a remote device,

At 440, a transceiver communicates data representing the operational parameters of the input or the output. In one embodiment, the transceiver communicating data includes the transceiver transmitting wireless signals to a remote device. In another embodiment, the transceiver communicating data includes the transceiver receiving wireless signals from a remote device. In yet another embodiment, the transceiver communicating data includes the transceiver both transmitting and receiving wireless signals to and from a remote device.

In one embodiment (not shown), the method 400 further comprises the step of the processor controlling the operation of the input or the output based on detected set points or thresholds associated with the input or the output and data received from a remote device.

FIG. 5 is a flow chart illustrating another example method 500 for wirelessly communicating operational parameters of an information technology (IT) equipment power supply, power distribution, or environment control apparatus. At 510, an IT equipment power supply, power distribution, or environmental control apparatus receives, from a remote device, data identifying the remote device or a user interface within the remote device. In an example embodiment, the IT equipment power supply, power distribution, or environmental control apparatus receives the data wirelessly. At 520, a processor determines a format in which to transmit data representing operational parameters of the IT equipment power supply, power distribution, or environmental control apparatus to the remote device based on the data identifying the remote device or the user interface. At 530, a transceiver transmits the data representing the operational parameters to the remote device in the determined format.

In one example, methodologies are implemented as processor executable instructions or operations provided on a computer-readable medium. Thus, in one example, a computer-readable medium may store processor executable instructions operable to perform the methods 400 or 500. While the above example method is described being provided on a computer-readable medium, it is to be appreciated that other example methods described herein can also be provided on a computer-readable medium.

While FIGS. 4 and 5 illustrate various actions occurring in serial, it is to be appreciated that various actions illustrated in FIGS. 4 and 5 could occur substantially in parallel. While a number of processes are described, it is to be appreciated that a greater or lesser number of processes could be employed and that lightweight processes, regular processes, threads, and other approaches could be employed. It is to be appreciated that other example methods may, in some cases, also include actions that occur substantially in parallel,

The following includes definitions of selected terms employed herein. The definitions include various examples, forms, or both of components that fall within the scope of a term and that may be used for implementation. The examples are not intended to be limiting. Both singular and plural firms of terms may be within the definitions.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

“Logic,” as used herein, includes but is not limited to hardware, firmware, software or combinations of each to perform a function or an action, or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection,” or a connection by which components are “operably connected to,” or “in circuit with” is one by which the operably connected components or the operable connection perform its intended purpose. For example, two components may be operably connected to each other directly or through one or more intermediate components. An “operable connection,” or a connection by which entities are “operably connected to” or “in circuit with” other entities is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

“Signal,” as used herein, includes but is not limited to one or more electrical, electromagnetic or optical signals, analog or digital signals, data, one or more computer or processor instructions, messages, a bit or bit stream, or other means that can be received, transmitted or detected.

“Software,” as used herein, includes but is not limited to, one or more computer or processor instructions that can be read, interpreted, compiled, or executed and that cause a computer, processor, or other electronic device to perform functions, actions or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servelet, an applet, instructions stored in a memory, part of an operating system or other types of executable instructions. It will be appreciated by one of ordinary skill in the art that the form of software may depend, for example, on requirements of a desired application, the environment in which it runs, or the desires of a designer/programmer or the like. It will also be appreciated that computer-readable or executable instructions can be located in one logic or distributed between two or more communicating, co-operating, or parallel processing logics and thus can be loaded or executed in serial, parallel, massively parallel and other manners.

Suitable software for implementing the various components of the example systems and methods described herein may be produced using programming languages and tools like Java, Java Script, Java.NET, ASP.NET, VB.NET, Cocoa, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium. Another form of software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software computers or other devices, or combinations of these.

Some portions of the detailed descriptions are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

While example systems, methods, and so on, have been illustrated by describing examples, and while the examples have been described in considerable detail, it is not the intention to restrict or in any way limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, and illustrative examples shown or described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

What is claimed is:

1. A power supply comprising:
at least one input port configured to operably connect to a power source;
at least one output port configured to operably connect to a power load;
at least one processor operably connected to the at least one input port and the at least one output port and configured to receive data representative of operational parameters of the at least one input port and the at least one output port; and
at least one transmitter operably connected to the at least one processor and configured to transmit data representative of the operational parameters.

2. The power supply of claim 1, where the operational parameters include at least one of current and voltage measured at at least one of the input port and the output port, and where the at least one transmitter is configured to wirelessly transmit data representative of the at least one of the current and the voltage.

3. The power supply of claim 1, further comprising:
a display for enabling a user to monitor the operational parameters; and
a control interface for enabling a user to control operation of the power supply.

4. The power supply of claim 1, further comprising:
at least one receiver configured to wirelessly receive data representative of the operational parameters.

5. The power supply of claim 4, wherein the operational parameters include one or more of set points and thresholds related to the one or more of the at least one input port and the at least one output port, and wherein the processor is configured to control the functionality of the one or more of the at least one input port and the at least one output port based on the one or more of the set points and the thresholds.

6. The power supply of claim 4, where the at least one receiver is configured to wirelessly receive, from a remote device, data identifying at least one of the remote device and a user interface within the remote device, where the at least one transmitter is further configured to wirelessly transmit the data representative of the operational parameters to the remote device, and where the power supply further includes:
a user interface logic configured to determine a format in which the data representative of the operational parameters is transmitted based on the data identifying the at least one of the device and the user interface.

7. The power supply of claim 6, where the at least one transmitter is configured to wirelessly transmit the data representative of the operational parameters in the determined format.

8. An information technology (IT) equipment power supply, power distribution, or environmental control apparatus, the apparatus comprising:
at least one input configured to operably connect to a power source;
at least one output configured to deliver power;
at least one processor in circuit with the at least one input and the at least one output and configured to receive data representing operational parameters of the at least one input and the at least one output; and
at least one wireless transmitter in circuit with the at least one processor and configured to wirelessly transmit data representing the operational parameters.

9. The apparatus of claim 8, where the apparatus is one of a power supply and a power distribution unit, where the power delivered is electrical power, where the operational parameters include at least one of current and voltage measured at at least one of the input and the output, and where the at least one wireless transmitter is configured to wirelessly transmit signals including data representing the at least one of the current and the voltage.

10. The apparatus of claim 8, where the unit is an environmental control unit, where the power delivered is thermal power, where the operational parameters include at least one of power and energy delivered by the output, and where the at least one transmitter is configured to wirelessly transmit signals including data representing the at least one of the power and the energy delivered by the output.

11. The apparatus of claim 8, further comprising:
at least one wireless receiver in circuit with the at least one processor and configured to wirelessly receive signals including data representing the operational parameters.

12. The apparatus of claim 8, further comprising:
a display for enabling a user to monitor the operational parameters; and
a control interface for enabling a user to control operation of the apparatus.

13. The apparatus of claim 8, further comprising:
at least one wireless receiver in circuit with the at least one processor and configured to wirelessly receive signals including data representing the operational parameters, where the operational parameters include one or more of set points and thresholds related to the one or more of the at least one input and the at least one output, and where the one or more of the set points and the thresholds controls the functionality of the one or more of the at least one input and the at least one output.

14. The apparatus of claim 8, further comprising:
at least one wireless receiver in circuit with the at least one processor and configured to wirelessly receive signals from a remote device including data identifying at least one of the remote device and a user interface within the remote device; and
a user interface logic configured to determine a format in which to transmit the data representing the operational parameters to the remote device based on the data identifying the at least one of the remote device and the user interface,
where the at least one wireless transmitter is configured to wirelessly transmit signals including the data representing the operational parameters to the remote device in the determined format.

15. A method for wirelessly communicating operational parameters of an information technology (IT) equipment power supply, power distribution, or environmental control apparatus, the method comprising the steps of:
an apparatus receiving power to at least one input from a power source;
the apparatus outputting power from at least one output;
a processor detecting operational parameters associated with at least one of the at least one input and the at least one output; and
a transceiver communicating wireless signals including data representing the operational parameters of the at least one of the at least one input and the at least one output.

16. The method of claim 15,
wherein the processor detecting operational parameters includes the processor measuring at least one of current and voltage at at least one of the at least one input and the at least one output, and
where the transceiver communicating wireless signals includes the transceiver transmitting signals including data representing at least one of the current and the voltage measured at the at least one of the input and the output.

17. The method of claim 15,
where the processor detecting operational parameters includes the processor determining at least one of power and energy at at least one of the at least one input and the at least one output, and
where the transceiver communicating wireless signals includes the transceiver transmitting signals including data representing the at least one of the determined power and energy.

18. The method of claim 15, where the transceiver communicating wireless signals includes the transceiver receiving signals including data representing operational parameters including one or more of set points and thresholds associated with the at least one of the at least one input and the at least one output.

19. The method of claim 18, further comprising the step of:
the processor controlling the operation of at least one of the at least one input and the at least one output based on the one or more of set points and thresholds associated with the one or more of the at least one input and the at least one output.

20. The method of claim 15, further comprising the steps of:
the transceiver receiving wireless signals from a remote device including data identifying at least one of the remote device and a user interface within the remote device; and
the processor determining a format in which to transmit the data representing the operational parameters to the remote device based on the data identifying the at least one of the remote device and the user interface,
wherein the transceiver communicating wireless signals includes the transceiver transmitting wireless signals including the data representing the operational parameters to the remote device in the determined format.
